(19) United States
(12) Patent Application Publication
(10) Pub. No.: US 2008/0238676 A1
(43) Pub. Date: Oct. 2, 2008

(54) Location based security data provisioning and management via RFID tags

(75) Inventors: Parmjit S. Dhillon, Mineola, NY (US); Thomas K. Roslak, Northport, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/729,869

(22) Filed: Mar. 30, 2007

(51) Int. Cl. G08B 13/14

(52) U.S. Cl. 340/572.1

(57) ABSTRACT

Systems and methods for securely provisioning and managing security data based on location are provided. In an installation having one or more secure locations, a physically secure container having a security data tag is provided in a secure location. Security data required to establish a secure application (e.g., secure communications with a network element or with one or more peripheral devices in the secure location), such as a digital certificate and/or cryptographic keys, is written into the security data tag. Each secure location within an installation may have different security needs and therefore the security data tags in different locations may store different sets of security data. When a reader or device requiring access to an application enters a secure location, the security data is read from the tag and used to establish a secure application.

### FIELD OF THE INVENTION

The present invention is related generally to the use of radio frequency identification (RFID) tags in information security applications.

### BACKGROUND OF THE INVENTION

The use of wireless voice and data networks has increased dramatically in the past decade. However, the increased flexibility and mobility offered by wireless networks comes with the cost of an increased vulnerability to attacks. The primary vulnerabilities of wireless networks are the lack of physical (or wired) links between the end user device and the network and the broadcast nature of the communications. For example, because an attacker does not need to gain physical access to a link, a wireless network is susceptible to eavesdropping attacks in which an attacker simply intercepts, using a wireless receiver, (and possibly replays) communications between parties. Most wireless protocols have developed security mechanisms to address the key vulnerabilities of wireless protocols. These security mechanisms typically use credentials to authenticate an end-user device to the wireless network and/or cryptographic keys to secure communications between the end-user device and the network.

In many instances, such as security for a building or installation, the credentials and cryptographic keys may be shared by all users within the building or installation. Therefore, if the credential or keys are compromised, the credentials and keys must be changed for all devices used within the building or installation, impacting a significant number of users.

Additionally, the provisioning and management of these credentials, cryptographic keys, and other security data (referred to generally as “security data”) is labor intensive, often requiring entry of the security data by an employee into each device. Alternatively, the security data may be transmitted to the device over a link having weak security. Thus, the security data is susceptible to interception by a malicious third party.

Therefore, what is needed are systems and methods to securely provision and manage security data for devices within a building or installation.

What is further needed are systems and methods to provide security data on a location basis for a building or installation to minimize the impact when some or all of the security data is compromised.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where one or more RFID tag readers communicate with an exemplary population of RFID tags.

FIG. 2 depicts an exemplary system for location based security data provisioning and management data via RFID tags, according to embodiments of the present invention.

FIG. 3 depicts a flowchart of an exemplary method for location based security data provisioning and management via RFID tags, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1.0 Introduction

Radio frequency identification (RFID) tags are electronic devices that may be affixed to items whose presence is to be detected and/or monitored. A tag may be active (i.e., having an internal power supply such as a battery), passive, or a combination of both (pass-active). The presence of an RFID tag, and therefore the presence of the item to which the tag is affixed, may be checked and monitored by devices known as “readers.” Readers typically transmit radio frequency signals to which the tags respond. Each tag can store a unique identification number and/or a data set (which can be read only, read/write, or write once, read many). The tags respond to the reader transmitted read signals by providing their identification number so that they can be identified.

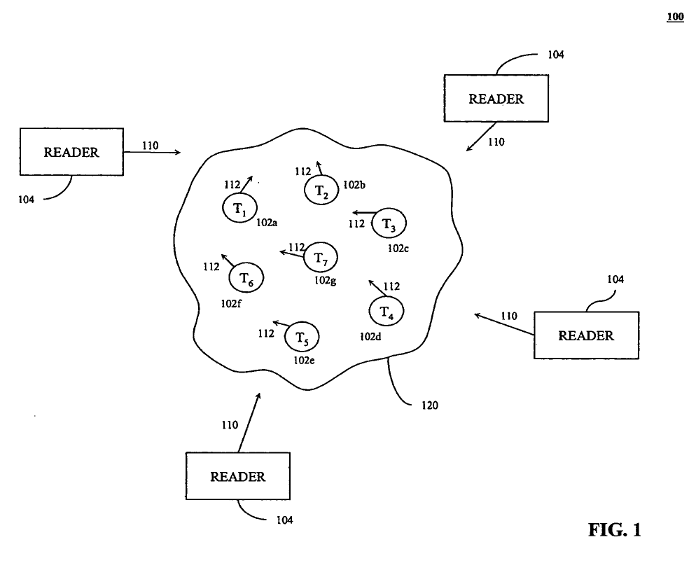

FIG. 1 illustrates an environment 100 where one or more RFID tag readers 104 communicate with an exemplary population of RFID tags, according to the present invention. As shown in FIG. 1, the population of tags 102 includes seven tags 102a-102g. According to embodiments of the present invention, a population of tags 102 may include any number of tags 102.

Exemplary environment 100 also includes one or more readers 104. These readers 104 may operate independently or may be coupled together to form a reader network. A reader 104 may be requested by an external application to address the population of tags 102. Alternatively, the reader may have internal logic that initiates communication. When the reader is not communicating with the population of tags, the reader 104 typically does not emit RF energy. This allows other readers, when present, to act upon the same population or a portion of the same population of tags, but from a different orientation, so as to achieve as complete of coverage with RF signals into the entire population of tags as possible. In addition, the same reader may act upon the same population of tags using a different frequency to increase tag coverage.

Signals 110 and 112 are exchanged between a reader 104 and the tags 102a-g according to one or more interrogation protocols. Signals 110 and 112 are wireless signals, such as radio frequency (PF) transmissions. Upon receiving a signal 110, a tag 102 may produce a responding signal 112 by alternatively reflecting and absorbing portions of signal 110 according to a time-based pattern or frequency. This technique for alternatively absorbing and reflecting signal 110 is referred to herein as backscatter modulation. The present invention is also applicable to RFID tags that communicate in other ways.

### 2.0 System for Location Based Security Data Provisioning and Management Via RFID Tags

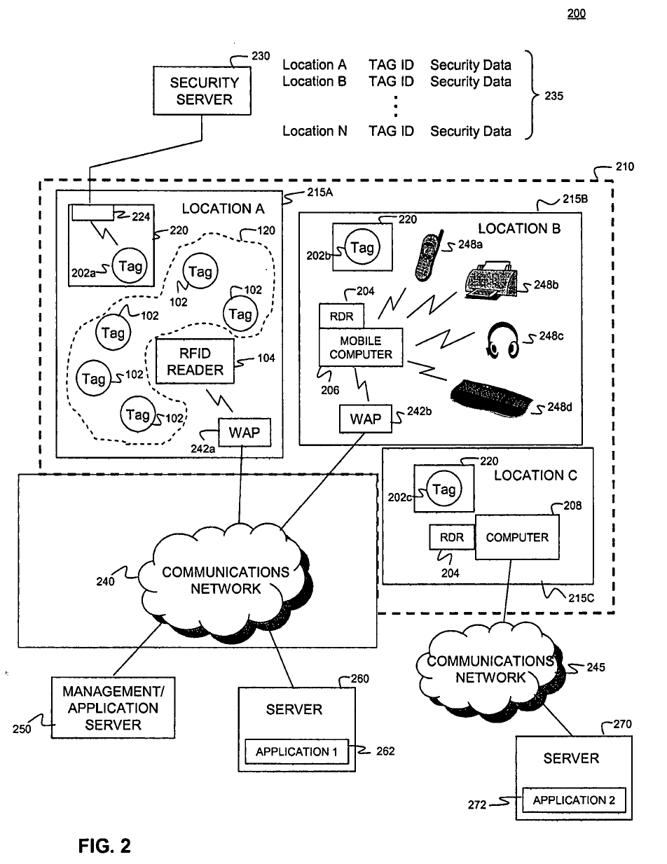

FIG. 2 depicts an exemplary system 200 for location based security data provisioning and management via RFID tags, according to embodiments of the present invention. As illustrated in FIG. 2, a building (or similar installation) 210 may have one or more physically secured locations 215 (e.g., a room, floor, portion of a floor, etc.). The physical security implemented at a particular location 215 may vary based on the needs of the individual or entity which owns or operates the location and/or the sensitivity of the data stored or activities performed in the location. For example, a location may have a mechanism for restricting access to the location to certain individuals.

A physically secured location 215 includes physically secure container 220. Physically secure container 220 includes a tag 202 designated for storing security data (referred to herein as a “security data tag”). Physically secure container 220 may also include a device 224 capable of writing data to a tag 202. Physically secure container 220 is designed to protect security data tag 202 and RFID mobile computing device 224 (when present) from physical or electronic tampering. In addition, physically secure container 220 may be designed to block RFID transmissions from exiting the container. This type of shielding limits the potential for a malicious individual or entity to eavesdrop on the RFID communications, intercept, and/or write the security data. For example, physically secure container 220 may be constructed from a conductor (e.g., an RF shielded box such as a metal box). In this embodiment, an external reader, such as RFID reader 104a, must be placed inside container 220 to read the security data tag 202.

In addition or alternatively, secure container 220 also includes a display, such as an LCD screen, for displaying security data in a form readable by an electronic device such as a bar code reader. When the display is present, a bar code reader (e.g., a 2D bar code reader) is placed inside the secure container to read the displayed data.

Security data tag 202 stores the security data to be used in communications between a device in location 215 and one or more network elements, applications, services, or resources. The data written into the security data tag 202 is dependent upon the type of data security required for the location. Security data tag 202 may store one or more cryptographic keys (e.g., a symmetric (e.g., secret) key or an asymmetric key pair), one or more digital certificates, authentication credentials (e.g., password, one-time password, etc.) or other security materials such as initialization vectors, etc required by a protocol, network element, application, service, and/or resource. For example, a first portion of the security data stored in security data tag 202 may be used to establish a secure application (e.g., communication with a network or network element, access to a peripheral device, access to an application, service, resource, etc.). A second portion of the security data may be used to authenticate a user or device to a network, application, etc.

Security data may be written to a security data tag 202 via a variety of mechanisms. For example, a secure container 220 may include a device 224 capable of writing data to a tag. In this example, the RFID write device 224 receives the security data from server 230. Server 230 is configured to manage security data for one or more locations 215. In an embodiment, server 230 manages security data for locations within a building 210. Alternatively, server 230 may manage security data for locations in multiple buildings or installations. Server 230 stores per-location security data 235. A per-location security data record may include a location identifier, an identification number of the data security tag assigned to the location, and the associated security data to be used for the location. Server 230 is coupled to one or more physically secure containers 220. In an embodiment, server 230 transmits security data for a location to a component, such as RFID writing device 224, in secure container 220. Server 230 may be physically or logically separated from the other components on a network associated with building 210 or locations 215. In an embodiment, server 230 is placed in a location 215. Additionally, one or more locations 215 may have a server 230 physically within the location. This server may be physically and/or logically separate from other servers 230.

In addition or alternatively, security data may be written to a security data tag 202 via an RFID reader 104. An RFID reader 104 may periodically be loaded with security data for one or more locations 215. The security data may be obtained from server 230, from another entity, or may be manually entered. A network administrator or a network security employee then enters a location 215 and transfers the security data for the location to the security data tag 202 using reader 104.

When present, a display in secure container 220 may receive security data updates from server 230. In addition or alternatively, secure container 220 may include a device coupled to the display for generating the security data or a portion of the security data for display.

System 200 allows for the flexible provisioning and management of security data on a per-location basis instead of on a per-building or institution basis. Additional, security data may be updated periodically or on an as needed basis by server 230 or via readers 104. For example, if key material for an individual location is compromised, server 230 or reader 104 may be used to update the key material for that location without the need to change the security data for other locations within the building or installation.

FIG. 2 illustrates three exemplary configurations for secure locations 215A-C. Location A includes an RFID reader 104 and a population of tags 120. RFID reader 104 communicates with the tag population 120 using an RFID protocol and with access point 242a using a wireless protocol such as 802.11. Location B includes a mobile computer 206 which communicates with one or more peripheral devices using a wireless protocol such as a wireless personal area network (WPAN) protocol (e.g, Bluetooth, Zigbee, etc) and communicates with access point 242b or similar network element using a wireless data protocol such as 802.11, GPRS, CDMA, CDPD, or WiMax. Location C includes a fixed computer 208 coupled via a wired connection to communications network 245. As would be appreciated by persons of skill in the art, other wireless protocols, data communications protocols, and/or configurations for secure locations 215 can be used with the present invention.

In location A, RFID reader 104 is configured to interrogate the population of tags 120 and periodically transmit data to and receive data, instructions, and/or applications from a management/application server 250 via communications network 240. In an embodiment, an RFID reader 104 communicates with communications network 240 via an access point 242b using a wireless protocol such as a WLAN protocol (e.g., 802.11). Such wireless protocols typically include security mechanisms such as, but not limited to, wired equivalent privacy (WEP), WiFi Protected Access (WPA), or WPA-2 for securing communications between the RFID reader and the access point. For example, if the security mechanism used is WPA or WPA-2, security tag 202a stores a digital certificate to be used to authenticate reader 104 in location A to access point 242a. Alternatively, if the security mechanism is WEP, security tag 202a may store one or more symmetric or secret keys to encrypt and/or decrypt communications between the reader and the access point. Additionally, management/application server 250 may enforce additionally security mechanisms for communications with RFID reader 104. For example, management/application server 250 may require data to and from server 250 be encrypted with a specific cryptographic key. This encryption key could also be stored within security data tag 202a.

In location B, mobile computer 206 is configured to wirelessly communicate with one or more peripheral devices present in location B and also to wirelessly communicate with access point 242b. In the environment of location B 215B, mobile computer 206 may have an integrated reader 204 for reading security data tag 202 or alternatively may have means for transferring data from reader 204 to mobile computer 206. As described above, the wireless protocol used by the mobile computer 206 to communicate with access point 242b may include a security mechanism such as WEP, WPA, or WPA-2. Additionally, the protocol used to communicate with the peripheral devices 248 may also include security mechanisms. The individual peripheral devices may also be assigned separate cryptographic keys and/or security data. Therefore, in addition to the security data required to communicate with access point 242b described above, security data tag 202 may also store one or more keys for communicating with peripherals 248a-n, possibly one per peripheral, as well as any security data required by the peripheral wireless protocol.

In location C, computer 208 is coupled to communications network 245 via a wired connection. In the environment of location C, computer 208 may have an integrated reader 204 for reading security data tag 202c or alternatively may have means for transferring data from reader 204 to computer 208. The security mechanisms required for computer 208 are determined by the protocol and/or application which computer 208 is accessing. For example, security data tag 202c may store one or more symmetric encryption keys, one or more asymmetric key pairs, one or more digital certifications, additional cryptographic material such as initialization vectors, authentication data, and/or any combination of these.

Reader 104, mobile computer 206, and/or computer 208 may additionally access an application, service or resource hosted on a server such as server 260 or server 270. The application, service, or resource may require additional security mechanisms for a user. For example, application 1 262 hosted on server 260 may require the entry of a shared secret when a device is attempting access to the application. This shared secret may also be stored in the security data tag 202 for each location requiring access to application 1. In a further example, application 2 272 hosted on server 270 may require the entry of a user name, password combination in order to access the application. This security data may also be stored in the security data tag for each location requiring access to application 2.

In a further example, a location 215 may have a device having a secure application requiring a key for access to the application. A user may obtain a portion of the key material (or similar data) from the network or other source. The remaining key material is physically read from the container, combined with the stored portion of the key material, and used to generate the key to access the application.

Communications network 240 may be a public data network (e.g., the Internet), a private data network, the public switched telephone network (PSTN), a wireless network, or any combination thereof. Communications network 245 may also be a public data network (e.g., the Internet), a private data network, the PSTN, or any combination thereof. In an embodiment, communications network 240 and communications network 245 are the same network.

### 3.0 Method for Location Based Security Data Provisioning and Management Via RFID Tags

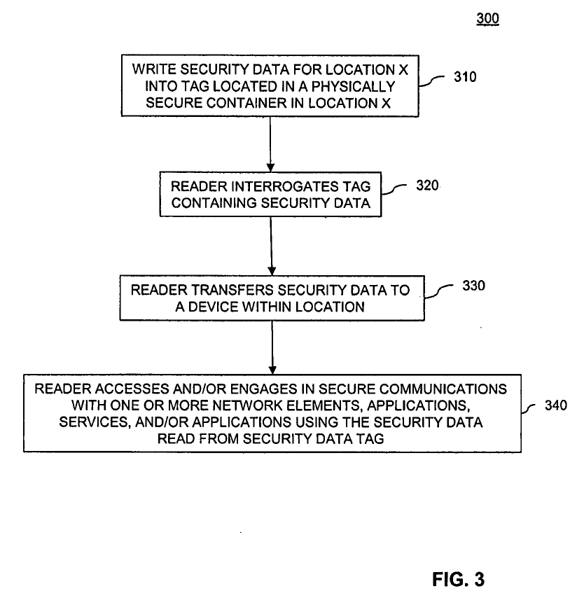

FIG. 3 depicts a flowchart 300 of an exemplary method for location based security data provisioning and management via RFID tags, according to embodiments of the present invention. Flowchart 300 is described with reference to the exemplary system of FIG. 2. However, flowchart 300 is not limited to that embodiment. Note that the steps of flowchart 300 do not necessarily have to occur in the order shown.

In step 310, security data for a location 215 is written into a security data tag 202 located in a physically secure container 220 in location 215. In an embodiment, server 230 transmits security data for the location 215 to a RFID writing device 224 included in physically secure container 220. Server 230 may transmit the data via a dedicated line, a private data connection or network, a public data network, or the PSTN 260. RFID computing device 224 then writes the security data to security data tag 202. In addition or alternatively, a reader 104 having the appropriate security data is placed within physically secure container 220. The reader 104 then writes the security data for the location 215 to security data tag 202.

In step 320, reader 104/204 interrogates the security data tag 202. In this step, reader 104/204 is placed within physically secure container 220 and a tag interrogation process is initiated. During the process, security data tag 202 transfers security data to reader 104/204. At the conclusion of step 320, reader 104/204 has the security data necessary to access and/or engage in secure communications with one or more network elements, applications, services, and/or applications.

In step 330, reader 104/204 transfers security data to a device within location 215 (such as a mobile computer 206 or computer 208). This step is optional.

In step 340, reader 104/204 or a device within location 215 accesses and/or engages in secure communications with one or more network elements, applications, services, and/or applications using the security data read from security data tag 202. For example, in location A 215A, reader 104 may need to transmit data read from tag population 120 to management/application server 250. In this example, reader 104 may use a digital certificate obtained from security data tag 202 to authenticate it to access point 242a. Additionally, reader 104 may use one or more secret keys obtained from security data tag 202 to encrypt and decrypt communications with management/application server 250.

### 4.0 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for provisioning security data based on location, comprising:
(a) writing a set of security data to a radio frequency identification (RFID) tag located in a container within a secure location;
(b) reading the set of security data from the RFID tag using an RFID reader placed at least partially within the container; and
(c) using at least a portion of the security data to establish a secure application.

2. The method of claim 1, further comprising:
prior to step (a), receiving the set of security data for the secure location from a security server.

3. The method of claim 2, wherein step (a) further comprises:
writing the set of security data to the RFID tag using an RFID writing device located within the container.

4. The method of claim 1, wherein step (a) further comprises:
transmitting the security data to a second RFID reader; and
writing the security data to the RFID tag using the second RFID reader, wherein the second RFID reader is placed at least partially within the container.

5. The method of claim 1, wherein the container is an RF shielded box.

6. The method of claim 1, wherein the set of security data includes a digital certificate for authenticating the RFID reader to a network element.

7. The method of claim 1, wherein the set of security data includes a symmetric key for encrypting communications between the RFID reader and a network element.

8. The method of claim 1, further comprising:
prior to step (c), transferring the security data from the RFID reader to a device within the secure location.

9. The method of claim 1, further comprising:
(d) using at least a second portion of the security data to authenticate the RFID reader to an application hosted on an application server.

10. The method of claim 8, further comprising:
(d) using at least a second portion of the security data to authenticate the device to an application hosted on an application server.

11. The method of claim 1, wherein the set of security data includes a secret key for communicating with a peripheral device.

12. The method of claim 1, further comprising:
(d) writing a second set of security data to a second RFID tag, wherein the second RFID tag is located in a container within a second secure location.

13. A system for provisioning security data in an installation having a plurality of secure locations, comprising:
a plurality of security data tags, wherein each security data tag is located within a container in one of the plurality of secure locations and wherein each security data tag includes a set of security data for establishing a secure application; and
a plurality of RFID readers, one per secure location, wherein each of the plurality of readers is configured to read the security data from the security data tags.

14. The system of claim 13, further comprising:
a security server including the set of security data for use in each of the secure locations; and
a RFID writing device coupled to the security server, the RFID writing device located within the container in a first secure location,
wherein the security server is configured to transfer a first set of security data for the first secure location to the security data tag in the container in the first secure location and wherein the RFID writing device is configured to write the first set of security data to the security data tag.

15. The system of claim 14, further comprising:
a second RFID writing device coupled to the security server, the second RFID writing device located within the container in a second secure location,
wherein the security server is configured to transfer a second set of security data for the second secure location to the security data tag in the container in the second secure location and wherein the second RFID writing device is configured to write the second set of security data.

16. The system of claim 14, wherein the first set of data includes a digital certificate for authenticating the RFID reader in the first location to a network element.

17. The system of claim 13, further including:
a device located in a first secure location, wherein the device is configured to receive a first set of security data from the RFID reader in the first secure location.

18. The system of claim 17, wherein the first set of data includes a digital certificate for authenticating the device in the first location to a network element.

19. The system of claim 14, wherein the first set of data includes a symmetric key for encrypting communications with a network element.

20. The system of claim 13, wherein the container in at least one of the plurality of secure locations is an RF shielded box.
